(19) United States
(12) Patent Application Publication
(10) Pub. No.: US 2012/0014235 A1
(43) Pub. Date: Jan. 19, 2012

(54) DISK RECORDING DEVICE AND DIGITAL PHOTO FRAME USING THE SAME

(75) Inventor: CHUNG-HSIN HUANG, Tu-Cheng (TW)

(73) Assignee: HON HAI PRECISION INDUSTRY CO., LTD., Tu-Cheng (TW)

(21) Appl. No.: 12/871,849

(22) Filed: Aug. 30, 2010

(30) Foreign Application Priority Data
Jul. 16, 2010 (TW) 99123407

(51) Int. Cl. G11B 20/10

(52) U.S. Cl. 369/47.15; G9B/20.009

(57) ABSTRACT

A disk recording device includes a processor, and a storage device, a memory reader, a display, an encoder, a disk recorder, all electrically connected to the processor. The storage device is configured for storing a first file. The memory reader is configured for reading the first file. The processor is configured for transforming the first file into a second file of a specific format compatible with the encoder. The encoder is connected to the processor and used for encoding the second file into a third file, and sending the third file to the processor. The processor is also configured for transforming the third file into a disk storable formatted file. The disk recorder is configured for recording the disk storable formatted file in the disk. The present embodiment also relates to a digital photo frame using the disk recording device.

### BACKGROUND

1. Technical Field

The present embodiment relates to a disk recording device and a digital photo frame using the disk recording device.

2. Description of Related Art

Currently, digital photo frame (DPF) can only display images stored in a memory of the DPF. If a user would like to record the images in the DPF on a disk for use in other devices, they have to use a conventional external device such as a read and write DVD module of a personal computer to record the image files, which is usually time-consuming.

Therefore, it is desirable to provide a disk recording device and a digital photo frame using the same that can overcome the above-mentioned limitations.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a functional block diagram of a digital photo frame (DPF), according to an exemplary embodiment.

FIG. 2 is a functional block diagram of a processor of the DPF of FIG. 1.

### DETAILED DESCRIPTION

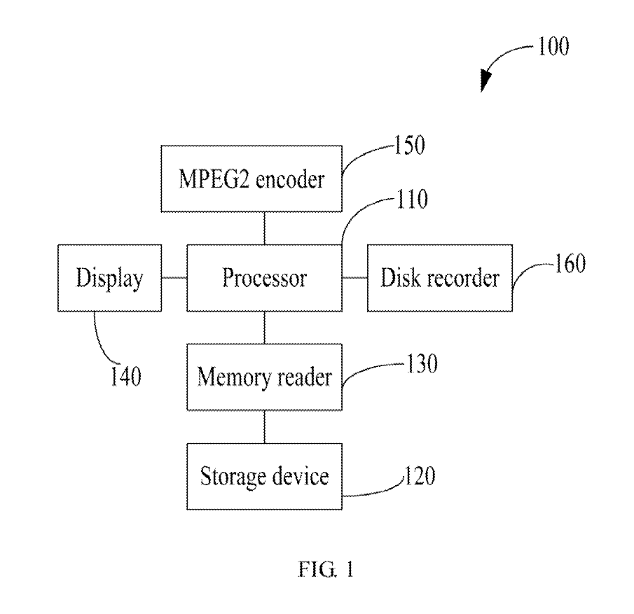

Referring to FIG. 1, a DPF 100, according to an exemplary embodiment, includes a processor 110, a storage device 120, a memory reader 130, a display 140, a moving picture expert group 2 (MPEG2) encoder 150, and a disk recorder 160, all electrically connected to the processor 110.

The storage device 120 may be any suitable memory commonly used in DPFs and is used for storing a number of first files. In this embodiment, the first files are JPEG formatted images. In this embodiment, the storage device 120 is a flash memory card and is received in the DPF 100.

The memory reader 130 is used for reading the first files.

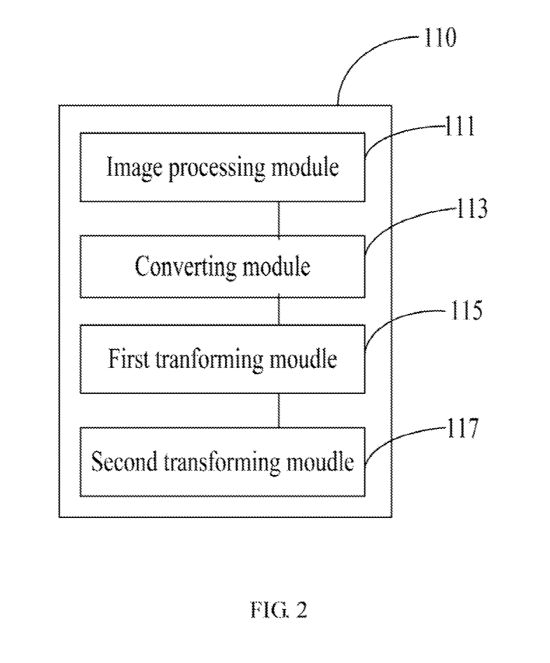

Referring to FIG. 2, the processor 110 includes an image processing module 111, a converting module 113, and a first transforming module 115. The image processing module 111 is used for combining all the first files into a single file to allow sequential display of the first files (slide show). The converting module 113 is used for converting the single file to a RGB formatted file, and driving the display 140 to display the RGB formatted file. The first transforming module 115 is used for transforming the RGB formatted file into a second file of a specific format compatible with the MPEG2 encoder 150 such as YPbPr, Separated Video (S-Video), composite video broadcast signal (CVBS), or BT.656 digital formats.

The MPEG2 encoder 150 includes a number of logical circuits used for encoding the second file into an MPEG2 formatted file (the suffixing name is .mpa or .mpg, etc) and returning the MPEG2 formatted file to the processor 110. It can be understood that, the MPEG2 encoder 150 uses hardware (i.e. a number of logical circuits) to encode the second file, and the read and write DVD module in the related art uses software to encode the second file. Therefore, the encoding speed of the MPEG2 encoder 150 is quicker than that of the read and write DVD module in the related art.

The processor 110 also includes a second transforming module 117 electrically connected to the first transforming module 115. The second transforming module 117 is used for transforming the MPEG2 formatted file into a disk storable formatted file, and then sending the disk storable formatted file to the disk recorder 160. In this embodiment, the disk storable formatted file is a DVD formatted file.

The disk recorder 160 is used for recording the disk storable formatted file onto a disk (not shown). The disk is received in a disk slot of the disk recorder 160.

In use, the image processing module 111 combines images in the first formatted files into a signal file. The converting module 113 convert the signal file into a RGB formatted file, and driving the display 140 to display the RGB formatted file. The first transforming module 115 transforms the RGB formatted file into a second file of a specific format compatible with the MPEG2 encoder 150. The MPEG2 encoder 150 encodes the second file into a MPEG2 formatted file and returns the MPEG2 formatted file to the second transforming module 117. The second transforming module 117 transforms the MPEG2 formatted file into a disk storable formatted file, and then sending the disk storable formatted file to the disk recorder 160. The disk recorder 160 records the disk storable formatted file into the disk.

It will be understood that the above particular embodiments and methods are shown and described by way of illustration only. The principles and the features of the present embodiment may be employed in various and numerous embodiments thereof without departing from the scope of the embodiment as claimed. The above-described embodiments illustrate the scope of the embodiment but do not restrict the scope of the embodiment.

What is claimed is:

1. A disk recording device, comprising:
an encoder;
a storage device configured for storing a first file;
a memory reader configured for reading the first file;
a processor electrically connected to the storage device and the memory reader, the processor configured for transforming the first file into a second file of a specific format compatible with the encoder, wherein the encoder is connected to the processor and configured for encoding the second file into a third file, and sending the third file to the processor and the processor is also configured for transforming the third file into a disk storable formatted file; and
a disk recorder connected to the processor and configured for recording the disk storable formatted file in a disk.

2. The disk recording device of claim 1, wherein the encoder is an MPEG2 encoder, the format of the second file is YPbPr, Separated Video, composite video broadcast signal or BT.656 digital signal format.

3. The disk recording device of claim 2, wherein the MPEG2 encoder comprises a plurality of logical circuits.

4. The disk recording device of claim 2, wherein the format of the third file is MPEG2 format.

5. The disk recording device of claim 1, wherein the disk storable formatted file is a DVD formatted file.

6. The disk recording device of claim 1, wherein the processor comprises a first transforming module and a second transforming module; the first transforming module is configured for transforming the first file into a second file of a specific format compatible with the encoder; the second transforming module is configured for transforming the third file into a disk storable formatted file.

7. A digital photo frame, comprising:
an encoder;
a storage device configured for storing a first file;
a memory reader configured for reading the first file;
a processor electrically connected to the storage device and the memory reader, the processor configured for transforming the first file into a RGB formatted file, and driving a display to display the RGB formatted file, then transforming the RGB formatted file into a second file of a specific format compatible with the encoder, wherein the encoder is connected to the processor and configured for encoding the second file into a third file, and sending the third file to the processor and the processor is also configured for transforming the third file into a disk storable formatted file; and
a disk recorder connected to the processor and configured for recording the disk storable formatted file in a disk.

8. The digital photo frame of claim 7, wherein the first file is a JPEG formatted file.

9. The digital photo frame of claim 8, wherein the processor is also configured for combining all the images in each of the first files into a single file to allow sequential display of the files, and converting the signal file to a RGB formatted file.

10. The digital photo frame of claim 9, wherein the processor comprises an image processing module, a converting module, a first transforming module and a second transforming module, the image processing module is configured for transforming the first file into MJPEG formatted file, the converting module is configured for converting the MJPEG formatted file to RGB formatted file and driving the display to display the RGB formatted file, the first transforming module is configured for transforming the RGB formatted file into a second file of a specific format compatible with the encoder, the second transforming module is configured for transforming the second file into a disk storable formatted file.

11. The digital photo frame of claim 7, wherein the storage device is a flash memory card and received in the DPF.

12. The digital photo frame of claim 7, wherein the encoder is an MPEG2 encoder and the format of the second file is YPbPr, Separated Video, composite video broadcast signal or BT.656 digital signal format.

13. The digital photo frame of claim 12, wherein the MPEG2 encoder comprises a plurality of logical circuits.

14. The digital photo frame of claim 12, wherein the format of the third file is MPEG2 format.

15. The digital photo frame of claim 7, wherein the disk storable formatted file is a DVD formatted file.
